(19) United States
(12) Patent Application Publication
(10) Pub. No.: US 2010/0251992 A1
(43) Pub. Date: Oct. 7, 2010

(54) Radial pulsed rotary internal combustion engine

(76) Inventor: Frank S. Davis, Houston, TX (US)

Correspondence Address: JAMES L. JACKSON;James L. Jackson, P.C., 10723 Sugar Hill Dr., Houston, TX, 77042, US

(21) Appl. No.: 12/384,448

(22) Filed: Apr. 6, 2009

(51) Int. Cl. F02B 53/04; F02D 9/08

(52) U.S. Cl. 123/236; 123/403

(57) ABSTRACT

A radial pulsed rotary engine a rotor mounted for rotation between two parallel circular discs and creates pulsed focused fuel/air mixture ignitions sequentially within many wedge shaped chambers of a flat circular rotor. The rotor has a number of wedge shaped chambers that are defined by a number of rotor partitions that extend from positions near the center of the rotor to positions at or near the outer periphery of the rotor and are sequentially in communication with a fuel/air supply, defined by one of the disks, and an outer peripheral portion that is sequentially in communication with exhaust discharge openings that are defined by a housing within which the rotor is positioned. Spark plugs are mounted to the housing and fire sequentially in response to the position of the rotor within the housing.

### BACKGROUND OF THE INVENTION

1. Field of the Invention

The present invention relates generally to rotary engines of the internal combustion variety. More particularly the present inventions concerns a radial pulsed rotary internal combustion engine creating pulsed focused fuel/air mixture ignitions sequentially within multiple wedge shaped chambers of a rotor. The present invention also concerns a radial pulsed rotary engine having a multi-chamber open-sided rotor and having parallel circular discs that serve as closures for the open sides of the rotor and with one of the discs being defined by a generally circular wall of a rotor housing.

2. Description of the Prior Art

Over the years, a number of rotary internal combustion engines have been conceived and developed in an effort to overcome various disadvantages of the more conventional reciprocating piston type internal combustion engines. For example, U.S. Pat. No. 892,206 of Apple, U.S. Pat. No. 1,552,272 of Carner, U.S. Pat. No. 1,584,346 of Ardin, U.S. Pat. No. 3,290,879 of Wilkins, U.S. Pat. No. 4,693,075 of Sabatiuk, U.S. Pat. No. 4,702,072 of Kielhorn, U.S. Pat. No. 5,709,088 of Acaster, U.S. Pat. No. 6,505,462 of Meholic and U.S. Pat. No. 6,725,646 of Callas et al are each representative of rotary internal combustion engine development spanning the period of from 1908 to the present. Radial internal combustion engines have been in extensive use, especially for the aeronautics industry, these engines employing radially arranged air cooled pistons and cylinders, with connecting rods and bearings translating the reciprocating movement of the pistons to rotary movement of an engine output shaft. Though many rotary turbine engines, jet engines, and the like have been successful especially in the field of aeronautics, few rotary internal combustion engines have been developed that have experienced extensive efficient service life for other industries.

### SUMMARY OF THE INVENTION

It is a principal feature of the present invention to provide a novel radial pulsed internal combustion engine having a rotor having a plurality of open sided wedge shaped combustion chambers that are defined by internal vanes, with the rotor operating within a rotor chamber having a fuel/air inlet near its center and a combustion gas discharge opening at its periphery.

It is another feature of the present invention to provide a novel radial pulsed internal combustion engine having controllable valving for fuel/air mixture intake and combustion gas discharge and having controllable spark plug ignition that functions sequentially for engine speed and power control.

Briefly, the various objects and features of the present invention are realized through the provision of a radial pulsed rotary engine creating pulsed focused fuel/air mixture ignitions sequentially within many chambers of a flat circular rotor having multiple chambers that radiate from the center of the rotor. The rotor has a number of wedge shaped chambers that are defined by a number of rotor partitions extending from positions near the center of the rotor to positions at or near the outer periphery of the rotor. The rotor is rotatable within a rotor housing that defines a circular rotor chamber that is defined by a rotor housing disk and a substantially cylindrical outer peripheral housing wall.

The rotor housing is also defined in part by a substantially circular rotor chamber closure disk or plate having sealing relation with the rotor partitions. Each of the rotor chambers is of wedge-shaped configuration and has an inner portion that is sequentially in communication with a fuel/air supply located at or near the central portion of one of the rotor housing disks or plates. Each rotor chamber has an outer portion that is sequentially in communication with exhaust discharge openings of the rotor housing.

The rotor system of the engine can be envisioned as a rotor mounted for rotation between two parallel circular discs which are located on each side of a desired number rectangular vanes radiating from the center region of the rotor, creating multiple wedge shaped compression and exhaust chambers between the two circular discs. The multi-chamber open-sided rotor has parallel circular disks that serve as closures for the open sides of the rotor and with one of the discs being defined by a generally circular wall of the rotor housing. Spark plugs are mounted to the rotor housing and fire sequentially in response to the position of the rotor within the housing.

### General Concept

The radial pulsed engine incorporates pulsed focused fuel/air ignition explosions from many chambers in a flat circular rotor having multiple chambers that radiate from the center of the rotor. Each of the rotor chambers is of essentially “wedge-shaped” configuration and the rotor has a plurality, i.e., eight wedge shaped chambers in a preferred embodiment of the present invention. The rotor may have a greater or lesser number of rotor chambers depending upon the design and power requirements of the radial pulsed engine. The rotor can be envisioned as two parallel circular discs above and below eight rectangular vanes radiating from the center of the discs, creating eight wedge shaped combustion chambers between the two substantially circular discs or walls. While the internal wall surfaces of the rotor housing may be of circular configuration, the external geometry of the rotor housing may be other than circular, so as to provide for engine or rotor mounting and to provide for attachment of engine peripheral equipment to the engine structure.

### Engine Rotor Construction

In the center of the flat circular rotor is located an inlet or intake port where an air and fuel mixture enters the chambers. A carburetor or fuel/air injection system provides a proper mixture and develops a pressure for sequential injection of the mixture into the radially inner portions of the combustion and exhaust chambers of the rotor. Fuel/air injection is sequential so that the combustion chambers are filled as the rotor rotates and is sequentially exhausted at the radially outer portion of the rotor by exhaust valving according to a firing and exhaust sequence.

On one side is a hole in the center of one of the discs. There is a shaft bolted to the center of the other disc. The shaft is mounted into stationary bearing blocks. A pipe with four rectangular slots evenly spaced with the area between the holes and the holes between the area have the same dimension. This “pipe” slides into the hole in the rotor side with the hole in it. The “pipe” is stationary while the rotor rotates. At the end of the pipe that fits into the rotor, the solid area closes off the opening to the narrow end of the pie shaped chambers so that the fuel/air mixture cannot flow into the chamber. As the rotor turns the stationary “pipe” valve times the flow of fuel/air mixture to the chambers. A similar valve is located around the outside of the rotor. This similar valve is mostly stationary, in that it will rotate enough to adjust the timing of the exhaust in the same way the fuel/air mixture intake valve can be adjusted for the correct intake timing. On the rotor on the opposite side of the “pipe” valve there are 8 spark plugs mounted to the upper half of each chamber. As the rotor spins the plugs move like the rotor of a distributor and fire sequentially to ignite the fuel/air mixture in the chamber.

### Ignition

The sequence of ignition of the compressed fuel may be set up to be one chamber at a time, four chambers at a time, all of the chambers at once (which will require a “pipe” modification) in the direction of rotation in the case of a differing number of valves than chambers.

One of the requirements for ignition of the fuel/air mixture is that the mixture is compressed to a predetermined extent to accomplish ignition and explosive-like combustion of the mixture. To accomplish fuel/air mixture compression during starting of the engine a starter motor which may be an electrically driven rotary motor, a compressed air driven rotary motor or any other rotary power source is employed to bring the rotor up to a starting speed. The inertia of the rotating rotor will be sufficient for compression of the mixture to a pressure for ignition of the mixture by an electric spark. Upon ignition of the fuel/air mixture the pressure within the rotor chamber will increase and will impart energy to the rotor. As the rotor chambers are sequentially activated by electric sparks controlled by a timing system, the speed of the rotor will be controlled according to the timing sequence thus providing rotor output torque to the rotor shaft for operating any mechanism for which the engine is a power source.

The radial pulsed engine incorporates pulsed focused fuel/air explosions from many chambers in a flat circular rotor with many chambers radiating from the center. Appearing like a pie pan with eight pieces of pie. The chambers in the disk rotor are shaped like the pieces of pie. In the center of the rotor is a hole where the air and fuel mixture enters the chambers. The rotor can be envisioned as two parallel circular discs above and below eight rectangular vanes radiating from the center of the discs creating eight pie shapes between the two circular disks. On one side is a hole in the center of one of the disks.

There as a shaft bolted to the center of the other disk. The shaft is mounted into stationary bearing blocks. A pipe with four rectangular slots evenly spaced with the area between the holes and the holes between the area have the same dimension. This “pipe” slides into the hole in the rotor side with the hole in it. The “pipe” is stationary while the rotor rotates. At the end of the pipe that fits into the rotor, the solid area closes off the opening to the narrow end of the pie shaped chamber so that the fuel/air mixture cannot flow into the chamber. As the rotor turns the stationary “pipe” valve times the flow of fuel/air mixture to the chambers. A similar valve is around the outside of the rotor. It too is mostly stationary, that is, it will rotate enough to adjust the timing of the exhaust in the same way the intake can be adjusted for the correct intake timing. On the rotor on the opposite side of the “pipe” valve there are eight spark plugs mounted into the upper half of each chamber. As the rotor spins the spark plugs move like the rotor of a distributor and ignite the fuel/air mixture in the chamber.

### Ignition

The sequence of ignition of the compressed fuel/air mixture may be set up to be one chamber at a time, four chambers at a time, all of the chambers at once, which will require a “pipe” modification, in the direction of rotation, in the reverse direction of rotation in the case of a differing number of valves than chambers.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is an exploded elevational view showing a radial pulsed rotary engine that embodies the principles of the present invention;

FIG. 2 is a partial sectional view taken along line 2-2 of FIG. 1 and showing the rotor and vane location and configuration in detail and further identifying the operational sequence of the engine;

FIG. 3 is an elevational view taken along line 3-3 of FIG. 1 and showing the clutch plate of the engine;

FIG. 4 is an isometric illustration showing one of the clutch engagement actuators of FIG. 3; and

FIG. 5 is an elevational view showing the actuating arm and other components of the clutch system of the engine.

### DETAILED DESCRIPTION OF PREFERRED EMBODIMENT

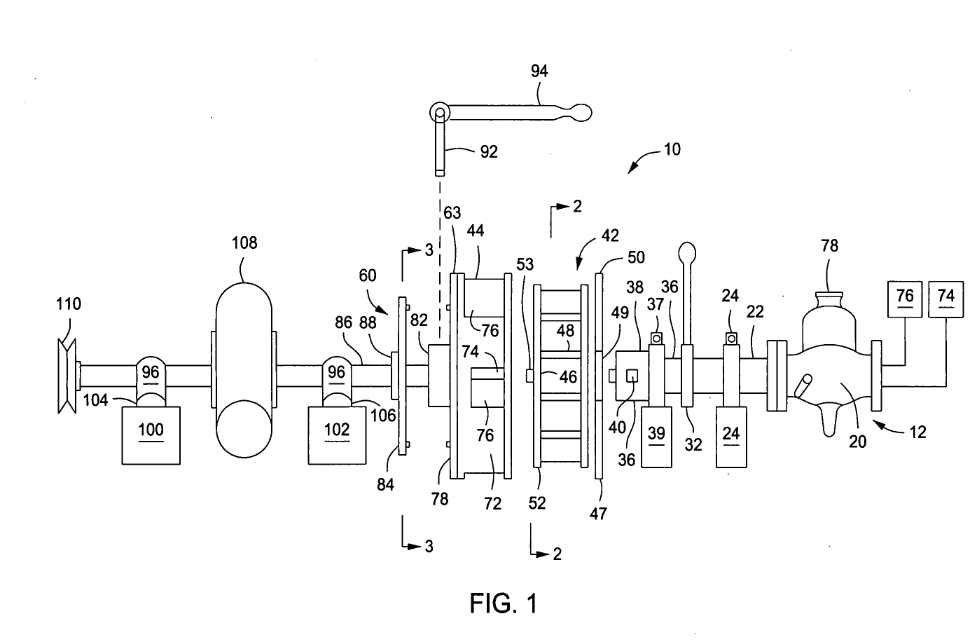

Referring now to the drawings and first to the exploded elevational illustration of FIG. 1, a radial pulsed rotary engine embodying the principles of the present invention is shown generally at 10. For purposes of simplicity and understanding the radial pulsed engine is shown by way of exploded illustration so that the various components may be visualized and more readily understood.

An air and fuel mixture is developed by a fuel/air mixture supply system shown generally at 12, being in the form of a carburetor, a fuel injection system or the like 14 which is in communication with a fuel supply source 16 and an air supply 18 and has a mixing chamber or system 20. The fuel/air mixture supply system 12 is bolted or otherwise connected to a fuel/air mixture supply conduit or pipe 22 which is in turn supported by support pedestals or bearing blocks 24 and 26 and corresponding mounting brackets 28 and 30. The mounting brackets provide bearing support for the fuel/air mixture supply conduit or pipe 22 and permit throttle controlled rotation of the fuel/air mixture supply conduit or pipe 22 sufficient for throttle operation.

Except for its rotational adjustment for throttle control, the fuel/air mixture supply conduit or pipe 22 is intended to remain substantially stationary during engine operation. A throttle valve actuator 32 is controlled by an actuating member 34, such as an actuating handle for manual operation or a throttle linkage for mechanical or automated operation. At the terminal end 36 of the fuel/air mixture supply conduit or pipe 22 is provided a mixture supply throttle valve 38 which is employed to control the dimension and thus fuel/air mixture supply of a mixture supply opening 40 of the fuel/air mixture supply conduit or pipe 22. The terminal end of the conduit 22 is supported for rotation by a bearing 37 that is supported by a support pedestal 39. The mixture supply throttle valve 38 is moved for throttle adjustment by the throttle valve actuating member or handle 34. The valve actuating member achieves controlled rotational movement of the fuel/air mixture supply conduit or pipe 22 for throttle valve adjustment and throttle control for the engine.

It should be borne in mind that the throttle valve actuator 34 may take the form of a throttle movement control mechanism which may be electronically, mechanically or pneumatically controlled, depending on the character of the speed and power control system of the engine.

As an alternative to rotation of the fuel/air mixture supply conduit or pipe 22 for throttle control, the conduit 22 may be essentially fixed and the throttle valve 38 may be selectively movable manually or by mechanized control for throttle and thus engine speed adjustment. The dimension and/or configuration of the throttle valve mixture supply opening 40 is adjusted as the throttle actuation member or handle is moved for throttle control.

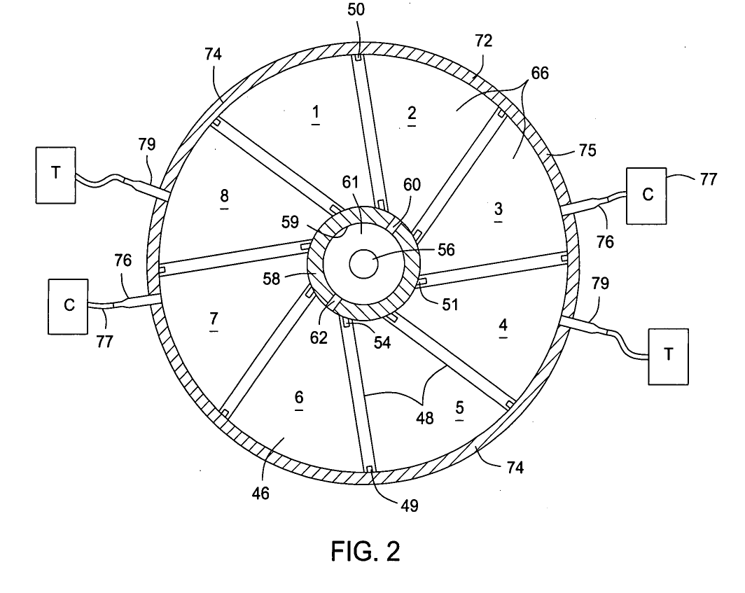

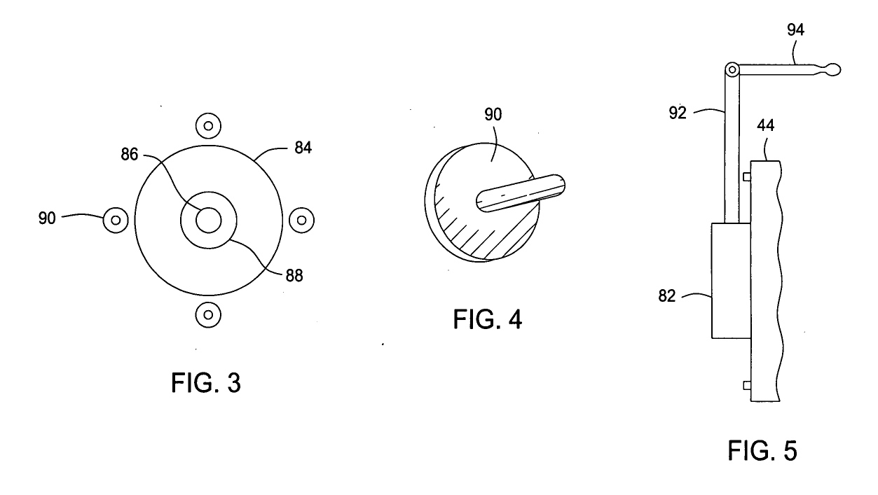

A rotor and rotor housing mechanism, shown generally at 42, is presented by means of the exploded elevational illustration of FIG. 1 and incorporates a rotor 44, also shown in FIGS. 2-5. The rotor and rotor housing mechanism 42 has a rotor plate or disk 46 to which is mounted a plurality of vane or partition members 48. A rotor housing plate or disk 47 is secured to the rotor housing and defines a central opening 49 through which is received a portion of the terminal end 36 of the fuel/air mixture supply conduit 22, including the throttle valve 38 of the mixture supply conduit. The rotor housing plate or disk 47 is sealed to the rotor housing structure and is also sealed to the terminal end 36 of the fuel/air supply conduit 22 such as by means of heat resistant seal members. The vane members are defined by substantially flat plates defining opposed surfaces of essentially planar configuration and have the outer ends 50 thereof located substantially co-extensive with the outer periphery 52 of the rotor plate or disk 46. The rotor vanes 48 are preferably provided with interior and exterior vane seals 49 and 51, respectively to effect dynamic seals with the cylindrical internal surface of the outer housing wall of the rotor housing and to effect dynamic seals with the outer cylindrical surface of an inner circular wall 58 which is also fixed to the rotor plate 46 as will be discussed in greater detail below. The vane seals 49 and 51 are best shown in FIG. 2.

To provide for the drive function of the rotor a rotor drive member 53 is fixed to and projects laterally from the central region of the rotor member. The inner ends 54 of each of the vane or partition members 48 are located in spaced relation with a fuel/air mixture inlet opening 56 that is located centrally of the rotor plate or disk 46. The cylindrical wall 58 is disposed in fixed and sealed assembly with the rotor plate or disk 46, such as by welding, and defines mixture inlet openings, such as shown at 60 and 62 through which a fuel/air mixture supply chamber 64 becomes in sequential communication with combustion chambers 66 as the rotor 44 is rotated during engine operation. The cylindrical wall 58 defines an inner cylindrical wall surface 59 forming a throttle valve receptacle 61 within which the terminal end 36 of the fuel/air mixture supply conduit and the throttle valve 38 are received. As the throttle valve 38 is controllably opened, fuel/air mixture from the mixture supply opening 40 is injected into the throttle valve receptacle 59 from the throttle valve mixture supply or discharge opening 40 and is communicated with the combustion chambers 2 and 6 of FIG. 2. The throttle valve 38 is selectively controlled to ensure proper fuel/air mixture injection into the combustion chambers as the rotor progresses through its repeating cycles of rotary movement.

As mentioned above, fuel/air mixture may be introduced into two or more chambers and exhausted from two or more chambers during each rotational cycle of rotor operation, depending on the characteristics of engine operation for which the engine is designed.

The rotor mechanism 44 is provided with a rotor housing 68 having a substantially planar wall 70 and an external generally cylindrical housing wall 72 defining a rotor chamber 73 within which the rotor mechanism 44 is rotatably received. The generally cylindrical housing wall 72 defines one or more exhaust openings 74 each having an exhaust valve 76 controllably associated therewith. The generally cylindrical housing wall 72 also defines one or more compression ports 75 with which is communicated a compression conduit 77 extending from a compression source “C”. The compression medium may be air or a fuel/air mixture which, when injected into the combustion chambers, increases the pressure of the fuel/air mixture to a condition for ignition and combustion. Ignition members 79, such as conventional spark plugs, are mounted within ignition ports of the rotor housing wall 72 and are sequentially energized according to an ignition sequence controlled by a timing system “T” to ignite the compressed combustible fuel/air mixture in the combustion chambers 4 and 8.

The rotor housing 68 is also provided with a housing panel or plate 78 which is rotatable to a sufficient extent for opening and closing movement of the exhaust valves to which the housing panel or plate 78 is connected in driving relation. In the alternative, the exhaust valves 76 may be opened and closed by a suitable electrically, pneumatically or hydraulically energized valve control mechanism that is responsive to an engine timing sequence.

A clutch assembly, shown generally at 80 in FIG. 1 and shown in greater detail in FIG. 6, is mounted to the external side of the housing panel or plate 78 and is moveable for adjustment of the dimensions of the exhaust openings 76. A rotor driven clutch plate 82 is mounted for rotation centrally of the housing panel or plate 78 and is engaged by the rotor drive member 53, thus providing for rotation of the clutch plate 82 relative to the rotor housing 68 by the rotor member 44. An adjustable clutch plate member 84 is fixed to an engine output shaft 86 by a clutch plate mount member 88 so that its rotation causes consequent rotation of the engine output shaft. Clutch drive engagement members 90, shown in greater detail in FIG. 6a, provide for driving engagement of the adjustable clutch plate member 84. The clutch assembly 80 is actuated by a clutch activation member 92 having a clutch activation handle or linkage 94. Though the drawings, for purposed of simplicity and understanding, show a manually operable clutch mechanism, it is to be borne in mind that a servo actuated clutch mechanism may be readily employed and may be responsive to engine conditions and load requirements for driving rotation of the engine output shaft 86 by the rotary pulse engine mechanism.

The output shaft 86 of the engine is supported for rotation by bearings 96 and 98, such as pillow block bearings or roller bearings that are secured to bearing support pedestals 100 and 102 by bearing retainer members 104 and 106. Between the bearings 96 and 98 a fly-wheel 108 is mounted to the engine output shaft 86 to stabilize engine operation and to ensure smooth sequential rotation of the rotor mechanism 44 as the fuel/air mixture within the combustion chambers 66 is compressed in preparation for ignition and during combustion as the rotor is propelled in the direction of rotation by the force of the resulting combustion gases.

A drive element 110, such as a pulley, gear drive train of a transmission or any other engine output drive member is fixed to the engine output shaft 86 and provides for transfer of energy to an automotive vehicle mechanism or any other mechanism that may be driven by the engine. The drive element translates the speed of the rotary output shaft 86 to provide the engine with output speed and torque as needed for the service that the engine is to perform.

### Operational Sequence

To facilitate ready understanding of the operational sequence of the rotary pulse engine the combustion chambers of the eight chambered embodiment with two exhaust ports have been numbered, thus permitting the various positions of the rotor vanes and chambers in relation to the exhaust ports of the rotor housing to be understood. The engine may have any suitable number of combustion chambers and any suitable number of exhaust ports without departing from the spirit and scope of the present invention.

The operational sequence of the rotary pulse engine of the present invention is shown in FIGS. 2-5. In FIG. 2 combustion chambers 1 and 5 are shown to be exhausting combustion gas since the exhaust openings or ports of the cylindrical rotor housing wall 72 are in registry therewith. The exhaust gas pressure within these combustion chambers is descending as the pressure vents via the exhaust ports 76, thereby establishing a pressure differential across the vane or partition 48 separating the exhausting combustion chamber 1 and 5 from the higher combustion gas pressure in the next succeeding combustion chambers 8 and 4. This pressure differential, acting on the rotor vanes provides the motive force for incremental movement of the rotor mechanism 44 through a portion of its rotary cycle.

Part of this motive force is employed to initiate compression of the fuel/air mixture that will have been injected into the preceding combustion chambers 2 and 6 immediately after the vane 48 has moved past the respective exhaust ports 76. A part of the motive force will have been employed to rotate the engine output shaft 86 and the fly-wheel 108, with the fly-wheel providing motive force in turn to ensure continuous rotation of the rotor at consistent rotational speed. For engine starting a starter motor, not shown, will in the usual fashion for internal combustion engines, have selective driving engagement with the fly-wheel or another engine component to establish engine rotation, fuel/air mixture supply and ignition system operation as needed for starting of the engine.

The fuel/air mixture will have been injected into the chambers 2 and 6 via the fuel/air inlet port 56 and the fuel/air mixture supply chamber 64. Thus the position of combustion chamber 2 in FIG. 2 can be described as the injection phase of engine operation for this particular combustion chamber.

As is also shown in FIG. 2, combustion chambers 3 and 7 are shown to be moving through the compression phase, when the pressure of the fuel/air mixture is increased in readiness for ignition. Pressure increase for ignition and combustion preparation is also enhanced by the pressure generating capability of the fuel/air mixture supply system, which may incorporate an injection pump or any other suitable system for development of a combustible fuel/air mixture in the combustion chambers of the rotor mechanism. As mentioned above, a compression medium is injected into the combustion chambers 3 and 7 via the injection port 75 of the outer housing wall 72 of the rotor housing from a compression pump or other source of compression C.

Ignition members 79, such as spark plugs, are mounted at ignition openings of the outer cylindrical wall 72 of the rotor housing. Though two ignition members are shown in FIG. 2, it is to be borne in mind that eight ignition members may be provided, each being mounted to the rotor housing wall 72 and being associated with an ignition timing system “T” for sequential firing at predetermined position of the rotor within the rotor housing. When the rotor has been rotated sufficiently to reach the position of combustion chambers 4 and 8 of FIG. 2, the ignition members 79 will be energized via electrical conductors from a spark distributor and develop an electrical ignition spark according to the timing sequence of rotor movement. This spark causes ignition of the pressurized combustible fuel/air mixture in the combustion chambers 4 and 8. The increasing gas pressure of mixture combustion significantly increases gas pressure within the combustion chambers and develops a resulting motive force on the leading vane of each of the ignited combustion chambers 4 and 8. Any tendency of the rotor to decrease in its rotary speed is counteracted by the stabilizing force of the engine flywheel 108. The engine operational cycle is continuous and repetitive. Engine speed or power changes are controlled by appropriate changes in the introduction of fuel/air mixture.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A radial pulsed rotary internal combustion engine, comprising:
an adjustable fuel/air mixture supply having a throttle valve for engine speed and power control and defining a throttle outlet;
a rotor housing having an outer substantially cylindrical wall defining at least one combustion gas discharge opening, said rotor housing having a substantially circular inner wall surface defining a rotor chamber;
a rotor mounted for rotation within said rotor housing and having a rotor plate having a plurality of substantially equally circumferentially spaced vanes mounted thereto and defining a plurality of wedge-shaped combustion chambers within said rotor and rotor housing;
a fuel/air mixture supply inlet opening being defined by said rotor housing and being in communication with said adjustable fuel/air mixture supply;
a clutch mechanism mounted to said rotor housing in selective driven connection with said rotor; and
an engine output shaft being disposed in driven relation with said clutch mechanism and being selectively rotated by said clutch mechanism.

2. The radial pulsed rotary internal combustion engine of claim 9, comprising:
said adjustable fuel/air mixture supply having a fuel supply source and an air supply source; and
a fuel/air mixing device in receiving relation with said fuel supply source and an air supply source and having a fuel/air mixture conduit having a mixture supply opening and a throttle valve disposed in controlling relation with said mixture supply opening.

3. The radial pulsed rotary internal combustion engine of claim 1, comprising:
said rotor defining an axis of rotation and having a fuel/air supply receptacle substantially concentric with said axis of rotation; and
said fuel/air supply being in the form of a conduit having a terminal portion thereof positioned within said fuel/air supply receptacle and locating said throttle valve within said fuel/air supply receptacle.

4. The radial pulsed rotary internal combustion engine of claim 1, comprising:
said rotor defining an axis of rotation and having a substantially cylindrical internal wall being substantially concentric with said axis of rotation and defining a fuel/air supply receptacle and defining at least one mixture inlet opening disposed for sequential communication with said combustion chambers during rotation of said rotor; and
said fuel/air supply having fuel/air supply conduit defining a conduit extremity disposed within said fuel/air supply receptacle and having a mixture supply opening and a throttle valve member located within said fuel/air supply receptacle and controlling supply of fuel/air mixture to said fuel/air supply receptacle.

5. The radial pulsed rotary internal combustion engine of claim 4, comprising:
a housing plate being mounted to said rotor housing and defining a central opening;
said fuel/air supply conduit having an extremity extending through said central opening and being located within said fuel/air supply receptacle and having a fuel/air mixture supply opening and a throttle valve in controlling relation with said fuel/air mixture supply opening; and
seal members establishing sealing of said extremity of said fuel/air supply conduit with said housing plate.

6. The radial pulsed rotary internal combustion engine of claim 1, comprising:
a fuel/air supply conduit having a terminal portion thereof in supplying relation with said rotor chamber and said rotor;
said fuel/air supply conduit being rotatable for throttle valve control; and
a throttle actuating member being mounted to said fuel/air supply conduit and being actuated for opening and closing movement of said throttle valve responsive to selective controlled rotation of said fuel/air supply conduit.

7. The radial pulsed rotary internal combustion engine of claim 1, comprising:
said rotor defining a clutch drive member;
said clutch mechanism being mounted to said rotor housing and having driven connection with said clutch drive member; and
a portion of said clutch mechanism being mounted in driving relation with said engine output shaft.

8. The radial pulsed rotary internal combustion engine of claim 7, comprising:
a clutch activation member having controlling connection with said clutch mechanism; and
a clutch actuation member being controllably moveable and achieving clutch engagement and disengagement with respect to said rotor.

9. A radial pulsed rotary internal combustion engine, comprising:
an adjustable fuel/air mixture supply having a throttle valve for engine speed and power control and defining a throttle outlet;
a rotor housing having an outer wall defining at least one combustion gas discharge opening, said rotor housing having a substantially circular inner wall surface defining a rotor chamber;
a rotor mounted for rotation within said rotor housing and having a centrally located wall defining a throttle valve receptacle having said throttle outlet and throttle valve positioned therein, said rotor having a plurality of substantially equally circumferentially spaced vanes defining a plurality of wedge-shaped combustion chambers therebetween;
a rotor plate being disposed in engagement with said rotor and defining a fuel/air mixture inlet opening substantially centrally thereof and in registry with said throttle valve receptacle;
a rotor housing plate being defined by said rotor housing and being disposed in engagement with said rotor and being disposed in substantially parallel relation with said rotor plate;
a clutch mechanism mounted to said rotor housing in selective driven connection with said rotor; and
an engine output shaft being disposed in driven relation with said clutch mechanism and being selectively rotated by said clutch mechanism.

10. The radial pulsed rotary internal combustion engine of claim 9, comprising:
said adjustable fuel/air mixture supply having a fuel supply source and an air supply source; and
a fuel/air mixing device in receiving relation with said fuel supply source and an air supply source and having a fuel/air mixture conduit having a mixture supply opening and a throttle valve disposed in controlling relation with said mixture supply opening.

11. The radial pulsed rotary internal combustion engine of claim 9, comprising:
said rotor defining an axis of rotation and having a fuel/air supply receptacle substantially concentric with said axis of rotation; and
said fuel/air supply having a terminal portion thereof positioned within said fuel/air supply receptacle and locating said throttle outlet and throttle valve within said fuel/air supply receptacle.

12. The radial pulsed rotary internal combustion engine of claim 9, comprising:
said rotor defining an axis of rotation and having a substantially cylindrical internal wall being substantially concentric with said axis of rotation and defining a fuel/air supply receptacle and defining at least one mixture inlet opening disposed for sequential communication with said combustion chambers during rotation of said rotor; and
A fuel/air supply conduit defining a conduit extremity disposed within said fuel/air supply receptacle and having a mixture supply opening and a throttle valve member located within said fuel/air supply receptacle and controlling supply of fuel/air mixture to said fuel/air supply receptacle.

13. The radial pulsed rotary internal combustion engine of claim 12, comprising:
a housing plate being mounted to said rotor housing and defining a central opening;
said conduit extremity of said fuel/air supply conduit extending through said central opening and being located within said fuel/air supply receptacle; and
seal members establishing sealing of said extremity of said fuel/air supply conduit with said housing plate.

14. The radial pulsed rotary internal combustion engine of claim 9, comprising:
said fuel/air supply conduit being rotatable; and
a throttle actuating member being mounted to said fuel/air supply conduit and being actuated for opening and closing movement of said throttle valve.

15. The radial pulsed rotary internal combustion engine of claim 9, comprising:
said rotor defining a clutch drive member;
said clutch mechanism being mounted to said rotor housing and having driven connection with said clutch drive member; and
a portion of said clutch mechanism being mounted in driving relation with said engine output shaft.

16. The radial pulsed rotary internal combustion engine of claim 15, comprising:
a clutch activation member having controlling connection with said clutch mechanism; and
a clutch actuation member being controllably moveable and achieving clutch engagement and disengagement with respect to said rotor member.
